(19) United States
(12) Patent Application Publication
(10) Pub. No.: US 2024/0288728 A1
(43) Pub. Date: Aug. 29, 2024

(54) ELECTRO-OPTICAL DEVICE AND ELECTRONIC APPARATUS

(71) Applicant: SEIKO EPSON CORPORATION, Tokyo (JP)

(72) Inventor: Yuki KOGA, CHITOSE-SHI (JP)

(73) Assignee: SEIKO EPSON CORPORATION, Tokyo (JP)

(21) Appl. No.: 18/586,573

(22) Filed: Feb. 26, 2024

(30) Foreign Application Priority Data
Feb. 27, 2023 (JP) 2023-028802

(51) Int. Cl. G02F 1/1335; G02F 1/1368

(52) U.S. Cl. CPC G02F 1/133526; G02F 1/1368

(57) ABSTRACT

An electro-optical device includes a transistor including a drain region, a pixel electrode provided corresponding to the transistor, a lens layer arranged in a layer between the transistor and the pixel electrode and containing silicon oxynitride, a first relay electrode arranged in a layer between the lens layer and the pixel electrode and electrically coupled to the pixel electrode via a first conductive portion, a passivation film arranged in a layer between the lens layer and the first relay electrode and being in contact with the lens layer, and a second conductive portion arranged in a through hole extending through the lens layer and the passivation film and electrically coupled to the first relay electrode.

The present application is based on, and claims priority from JP Application Serial Number 2023-028802, filed Feb. 27, 2023, the disclosure of which is hereby incorporated by reference herein in its entirety.

### BACKGROUND

### 1. Technical Field

The present disclosure relates to an electro-optical device and an electronic apparatus.

### 2. Related Art

As electronic apparatuses such as projectors, for example, electro-optical devices such as liquid crystal display devices of which optical characteristics can be changed for each pixel are used. An electro-optical device described in JP-A-2021-167884 is known as an example of electro-optical devices.

The electro-optical device described in JP-A-2021-167884 includes a first substrate, a second substrate, and a liquid crystal layer arranged between these substrates. The second substrate includes a substrate body such as a quartz substrate, a switching element, a relay electrode, a lens portion, a pixel electrode, and a conductive portion. The switching element, the relay electrode, the lens portion, and the pixel electrode are arrayed in the stated order from the substrate body. Further, the relay electrode is electrically coupled to a drain region of the switching element. Further, the relay electrode and the pixel electrode are electrically coupled to each other via the conductive portion. Thus, the pixel electrode is electrically coupled to the drain region of the switching element via the relay electrode and the conductive portion. Further, the lens layer contains silicon oxynitride.

When the conductive portion is provided inside a through hole extending through a lens, the drain region and the pixel electrode can be electrically coupled to each other at a position, such as the lens portion, where a thickness is required.

For example, the second substrate described in JP-A-2021-167884 can be manufactured in the following manner. For example, a plurality of element portions each including the switching element, the relay electrode, the lens portion, the pixel electrode, and the conductive portion are formed at a wafer such as a quartz substrate, and the wafer is individualized for each of the element portions. Through individualization, a plurality of second substrates are obtained.

When the second substrate is manufactured, a conductive film is formed inside the through hole extending through the lens portion and at the upper surface of the lens portion, and then, the conductive film is partially removed. With this, the conductive portion provided in the through hole is formed. When the conductive portion is formed, there is a problem in that film peeling of the conductive portion occurs at the outer peripheral portion of the wafer.

As a result of keen examination, it is conceived that, when the lens layer contains silicon oxynitride, nitrogen leakage changed close contact between the lens layer and the conductive layer, which causes film peeling. The peeled film may cause fine scratches on the lens portion, or may cause arching. As a result, the yield of the second substrate is decreased, and hence quality and reliability of the electro-optical device may be degraded.

### SUMMARY

According to one aspect of the present disclosure, an electro-optical device includes a transistor including a drain region, a pixel electrode provided corresponding to the transistor, a lens layer arranged in a layer between the transistor and the pixel electrode and including silicon oxynitride, a first relay electrode arranged in a layer between the lens layer and the pixel electrode and electrically coupled to the pixel electrode via a first conductive portion, a passivation film arranged in a layer between the lens layer and the first relay electrode and being in contact with the lens layer, and a second conductive portion arranged in a through hole extending through the lens layer and the passivation film and electrically coupled to the first relay electrode.

### BRIEF DESCRIPTION OF THE DRAWINGS

FIG. 1 is a plan view of an electro-optical device according to a first embodiment.

FIG. 2 is a cross-sectional view taken along line A-A of the electro-optical device illustrated in FIG. 1.

FIG. 3 is an equivalent circuit diagram illustrating an electrical configuration of a first substrate in FIG. 1.

FIG. 4 is a diagram illustrating a cross-sectional structure of a display region of the first substrate in FIG. 2.

FIG. 5 is a diagram illustrating arrangement of a plurality of pixel electrodes, a semiconductor layer, and a second capacitance electrode in FIG. 2 in plan view.

FIG. 6 is a diagram illustrating a part of the first substrate in FIG. 4.

FIG. 7 is a plan view illustrating a part of the first substrate in FIG. 6.

FIG. 8 is a view illustrating a flow of a method of manufacturing a part of the first substrate in FIG. 6.

FIG. 9 is a diagram for describing a light-transmitting layer formation step.

FIG. 10 is a diagram for describing a lens layer formation step.

FIG. 11 is a diagram for describing a passivation film formation step.

FIG. 12 is a diagram for describing a through hole formation step.

FIG. 13 is a diagram for describing a second conductive portion formation step.

FIG. 14 is a diagram for describing the second conductive portion formation step.

FIG. 15 is a diagram for describing a first relay electrode formation step.

FIG. 16 is a diagram for describing the first relay electrode formation step.

FIG. 17 is a cross-sectional view illustrating a second conductive portion in a modification example.

FIG. 18 is a cross-sectional view illustrating a part of a first substrate according to a second embodiment.

FIG. 19 is a cross-sectional view illustrating a part of a first substrate according to a third embodiment.

FIG. 20 is a perspective view of a personal computer that is an example of an electronic apparatus.

FIG. 21 is a plan view illustrating a smartphone that is an example of the electronic apparatus.

FIG. 22 is a schematic diagram illustrating a projector that is an example of the electronic apparatus.

### DESCRIPTION OF EMBODIMENTS

Preferred embodiments according to the present disclosure are described below with reference to the accompanying drawings. Note that in the drawings, the dimensions and scales of the components may differ as appropriate from the actual dimensions or scales, and some portions are schematically illustrated to facilitate understanding. Also, the scope of the present disclosure is not limited to these forms unless the present disclosure is specifically described as being limited in the following description.

### 1. Electro-optical Device

### A. First Embodiment

### A-1. Overview of Electro-optical Device 100

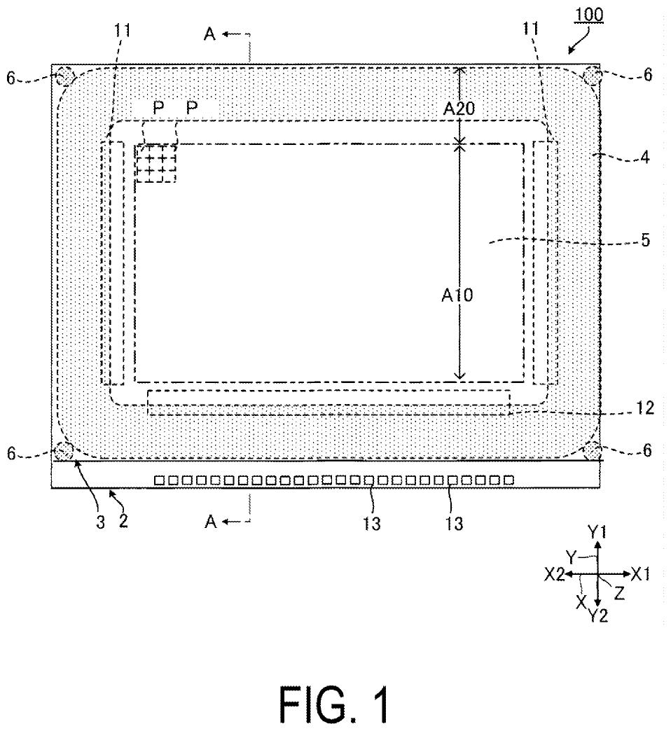

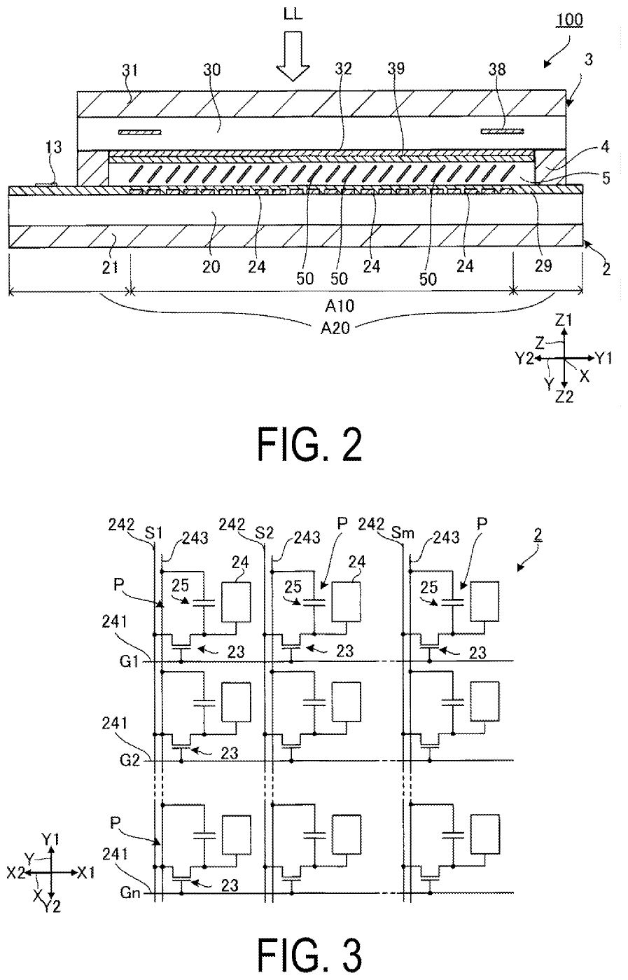

FIG. 1 is a plan view of an electro-optical device 100 according to a first embodiment. FIG. 2 is a cross-sectional view taken along line A-A of the electro-optical device 100 illustrated in FIG. 1. Hereinafter, for convenience of description, description is made while using an X-axis, a Y-axis, and a Z-axis orthogonal to one another as appropriate. Further, one direction along the X-axis is referred to as an X1 direction, and a direction opposite to the X1 direction is referred to as an X2 direction. Similarly, one direction along the Y-axis is referred to as a Y1 direction, and a direction opposite to the Y1 direction is referred to as a Y2 direction. One direction along the Z axis is referred to as a Z1 direction, and a direction opposite to the Z1 direction is referred to as a Z2 direction.

Further, in the present specification, an “electrical coupling” between an element a and an element B includes a configuration in which the element a and the element B are directly bonded to each other and electricity is conducted therebetween, as well as a configuration in which electricity is indirectly conducted between the element a and the element B via another conductor.

The electro-optical device 100 illustrated in FIG. 1 and FIG. 2 is a liquid crystal device of an active matrix drive type including a thin film transistor (TFT) as a switching element for each of pixels.

The electro-optical device 100 includes a first substrate 2, a second substrate 3, a frame-shaped sealing member 4, and a liquid crystal layer 5. As illustrated in FIG. 2, the first substrate 2, the liquid crystal layer 5, and the second substrate 3 are arranged in the stated order in the Z1 direction. Note that viewing from the Z1 direction or the Z2 direction, which is a direction in which the first substrate 2, the liquid crystal layer 5, and the second substrate 3 overlap with each other, is referred to as “plan view”. Further, although a planar shape of the electro-optical device 100 illustrated in FIG. 1 is a rectangular shape, the shape may have a polygonal shape or a circular shape other than the rectangular shape.

The electro-optical device 100 is a light-transmitting type, and the first substrate 2 and the second substrate 3 have a light-transmitting property. As illustrated in FIG. 2, light LL is incident on the second substrate 3, and then is modulated while being emitted from the first substrate 2, whereby an image is displayed. Note that the light may be incident on the first substrate 2 and be modulated while being emitted from the second substrate 3, whereby an image is displayed. Further, the “light-transmitting property” means transmissivity with respect to visible light, and may mean a transmittance of visible light of 50% or more.

The first substrate 2 includes a substrate 21, a layered body 20, a plurality of pixel electrodes 24, and an alignment film 29. The substrate 21, the layered body 20, the plurality of pixel electrodes 24, and the alignment film 29 are layered in the stated order in the Z1 direction.

The substrate 21 is a flat plate having a light-transmitting property and an insulating property, and is constituted by, for example, a glass substrate or a quartz substrate. The layered body 20 has a light-transmitting property. The layered body 20 is provided with a transistor, various wiring lines, and the like. The plurality of pixel electrodes 24 are arranged at the layered body 20. The plurality of pixel electrodes 24 are used for applying an electric field to the liquid crystal layer 5. Each of the plurality of pixel electrodes 24 contains a transparent conductive material such as indium tin oxide (ITO), indium zinc oxide (IZO), and fluorine-doped tin oxide (FTO). Note that a plurality of dummy pixel electrodes for noise reduction and an ion trap electrode may be provided outside of the plurality of pixel electrodes 24. Further, the alignment film 29 has a light-transmitting property and an insulating property. The alignment film 29 is in contact with the liquid crystal layer 5, and aligns liquid crystal molecules 50 in the liquid crystal layer 5. The alignment film 29 is arranged covering the plurality of pixel electrodes 24. The material of the alignment film 29 is polyimide, silicon oxide, and the like, for example.

As illustrated in FIG. 1, a scanning line drive circuit 11, a data line drive circuit 12, and a plurality of external terminals 13 are arranged at the first substrate 2. Some of the plurality of external terminals 13 are coupled to a wiring line drawn from the scanning line drive circuit 10, which is omitted in illustration. Further, the plurality of external terminals 13 include an external terminal 13 to which a constant potential Vcom is applied.

The second substrate 3 illustrated in FIG. 2 is arranged facing the first substrate 2. The second substrate 3 includes a substrate 31, a layered body 30, a counter electrode 32, an alignment film 39, and a parting edge 38. The substrate 31, the layered body 30, the counter electrode 32, and the alignment film 39 are layered in the stated order in the Z2 direction.

The substrate 31 is a flat plate having a light-transmitting property and an insulating property, and is constituted by, for example, a glass substrate or a quartz substrate. The layered body 30 includes a plurality of insulating films. Each of the plurality of insulating films has a light-transmitting property and an insulating property, and is made of an inorganic material containing silicon such as silicon oxide. For example, the layered body 30 includes a micro lens. The layered body 30 is provided with the parting edge 38. The parting edge 38 is a parting edge that has a light-blocking property and surrounds the plurality of pixel electrodes 24 in plan view. Note that the “light-blocking property” means a light-blocking property against visible light, and may mean a transmittance of visible light of less than 50%, and may mean a transmittance of visible light of 10% or less. The counter electrode 32 faces the plurality of pixel electrodes 24 through the liquid crystal layer 5. The counter electrode 32 is used for applying an electric field to the liquid crystal layer 5. The counter electrode 32 has a light-transmitting property and conductivity. The counter electrode 32 contains, for example, a transparent conductive material such as ITO, IZO, and FTO. The alignment film 39 has a light-transmitting property and an insulating property. The alignment film 39 aligns the liquid crystal molecules 50. The material of the alignment film 39 is polyimide, silicon oxide, and the like, for example.

Further, a plurality of inter-substrate conduction materials 6 illustrated in FIG. 1 are provided between the second substrate 3 and the first substrate 2. The plurality of inter-substrate conduction materials 6 are conduction materials for electrically coupling the first substrate 2 and the second substrate 3 to each other. The inter-substrate conduction material 6 is coupled to any external terminal 13 of the plurality of external terminals 13 via a drawn wiring line arranged at the first substrate 2, which is omitted in illustration. The constant potential Vcom is applied to the counter electrode 32.

The sealing member 4 is arranged between the first substrate 2 and the second substrate 3. The sealing member 4 contains a UV curable material such as an epoxy resin. UV is an abbreviation for ultraviolet. In particular, UV refers to light having a wavelength from 100 nm to 400 nm. Further, the sealing member 4 may include a gap material constituted by an inorganic material such as glass.

The liquid crystal layer 5 is arranged within a region surrounded by the first substrate 2, the second substrate 3, and the sealing member 4. The liquid crystal layer 5 is an electro-optical layer of which the optical characteristics change in accordance with the electrical field. The liquid crystal layer 5 includes the liquid crystal molecules 50. The liquid crystal molecules 50 has positive or negative dielectric anisotropy. The alignment of the liquid crystal molecules 50 changes in accordance with the voltage applied to the liquid crystal layer 5.

As illustrated in FIG. 1, the electro-optical device 100 includes a display region A10 in which an image is displayed, and a peripheral region A20 provided outside the display region A10 in plan view. A plurality of pixels P arranged in a matrix form are provided in the display region A10. The plurality of pixel electrodes 24 are arranged in a one-to-one relationship with respect to the plurality of pixels P. Meanwhile, the above-mentioned counter electrode 32 is a common electrode that is commonly provided for the plurality of pixels P. Further, the scanning line drive circuit 11, the data line drive circuit 12, and the plurality of external terminals 13 that are described above are arranged in the peripheral region A20.

The electro-optical device 100 is applied to, for example, a display device that performs color display, such as a personal computer and a smartphone, which is described below. When the electro-optical device 100 is applied to the display device, a color filter is used as appropriate for the electro-optical device 100. Further, the electro-optical device 100 is applied to, for example, a projection type projector, which is described below. In this case, the electro-optical device 100 serves as a light valve. In this case, the color filter is omitted from the electro-optical device 100.

### A-2. Electrical Configuration of First Substrate 2

FIG. 3 is an equivalent circuit diagram illustrating an electrical configuration of the first substrate 2 in FIG. 1. As illustrated in FIG. 3, the first substrate 2 includes a plurality of transistors 23, n scanning lines 241, m data lines 242, and n constant potential lines 243. Those lines are provided at the layered body 20 in FIG. 2. Note that n and m are integers equal to or greater than 2. The transistor 23 is arranged corresponding to each of intersections between the n scanning lines 241 and the m data lines 242. Each of the transistors 23 is, for example, a FT that serves as a switching element. Each of the transistors 23 includes a gate, a source, and a drain.

Each of the n scanning lines 241 extends in the X1 direction, and the n scanning lines 241 are arranged at equal intervals in the Y1 direction. The n scanning lines 241 are electrically coupled to the gates of the plurality of corresponding transistors 23. The n scanning lines 241 are electrically coupled to the scanning line drive circuit 11 illustrated in FIG. 1. Scanning signals G1, G2 . . . and Gn are supplied line-sequentially from the scanning line drive circuit 11 to the 1 to n scanning lines 241.

Each of the m data lines 242 illustrated in FIG. 3 extends in the Y1 direction, and the m data lines 242 are arranged at equal intervals in the X1 direction. The m data lines 242 are electrically coupled to the sources of the plurality of corresponding transistors 23. The m data lines 242 are electrically coupled to the data line drive circuit 12 illustrated in FIG. 1. Image signals S1, S2 . . . and Sm are supplied in parallel from the data line drive circuit 12 to the 1 to m data lines 242.

The n scanning lines 241 and the m data lines 242 illustrated in FIG. 3 are electrically insulated from each other, and are arranged in a grid pattern in plan view. A region surrounded by two adjacent scanning lines 241 and two adjacent data lines 242 corresponds to a pixel P. The transistor 23, the pixel electrode 24 and a capacitance element 25 are provided for each of the pixels P. The pixel electrodes 24 are provided corresponding to the transistors 23. One transistor 23 is arranged corresponding to one pixel electrode 24. Each of the pixel electrodes 24 is electrically coupled to the drain of the corresponding transistor 23.

Each of the n constant potential lines 243 extends in the Y1 direction, and the n constant potential lines 243 are arranged at equal intervals in the X1 direction. The constant potential Vcom is applied to each of the constant potential lines 243. Each of the constant potential lines 243 is a capacitance line that is electrically coupled to one of the two electrodes of the corresponding capacitance element 25. Each of the capacitance elements 25 is a holding capacitor for holding a potential of the pixel electrode 24. The capacitance element 25 is provided in a one-to-one relationship for the transistor 23. Further, the other of the two electrodes of each of the capacitance elements 25 is electrically coupled to the pixel electrode 24 and the drain of the transistor 23.

When the scanning signals G1, G2 . . . and Gn are sequentially activated, and the n scanning lines 241 are sequentially selected, the transistor 23 coupled to the selected scanning line 241 is turned on. Then, the potential corresponding to the image signals S1, S2 . . . and Sm with values corresponding to the gradation to be displayed through the m data lines 242 is applied to the pixel electrode 24 of the pixel P corresponding to the selected scanning line 241. Accordingly, a voltage corresponding to the gradation to be displayed is applied to a liquid crystal capacitor formed between the pixel electrode 24 and the counter electrode 32, and the alignment of the liquid crystal molecules 50 is changed according to the applied voltage. In addition, the applied voltage is held by the capacitance element 25. Such a variation in the alignment of the liquid crystal molecules 50 causes the light LL to be modulated, to thus enable grayscale display.

### A-3. Cross-Sectional Structure of Display Region A10 of First Substrate 2

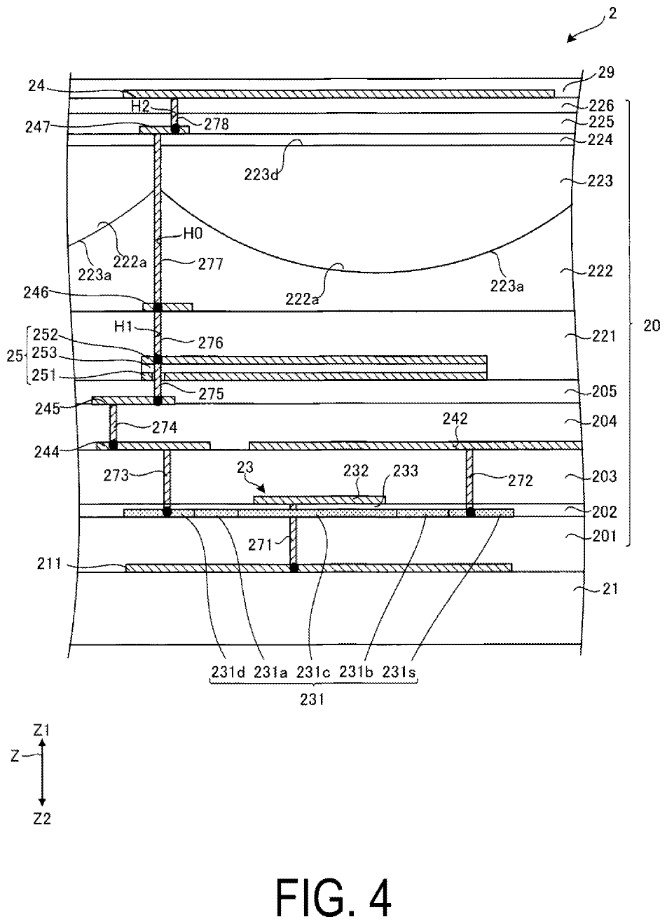

FIG. 4 is a diagram illustrating a cross-sectional structure of the display region A10 of the first substrate 2 in FIG. 2. As described above, the first substrate 2 includes the substrate 21, the layered body 20, the plurality of pixel electrodes 24, and the alignment film 29. FIG. 4 illustrates a cross-section corresponding to one pixel electrode 24.

Further, as illustrated in FIG. 4, the layered body 20 includes an insulating layer 201, an insulating layer 202, an insulating layer 203, an insulating layer 204, an insulating layer 205, a first optical path length adjustment layer 221, a light-transmitting layer 222, a lens layer 223, a passivation film 224, a second optical path length adjustment layer 225, and a protective layer 226 that are layered sequentially from the substrate 21. Each of the layers has a light-transmitting property and an insulating property. Each material of the insulating layers 201 to 205 is an inorganic material containing silicon such as silicon oxide and silicon oxynitride. Further, the transistor 23, the data line 242, and the like, which are described above, are arranged at the layered body 20.

A light-blocking layer 211 is arranged at the substrate 21. The light-blocking layer 211 is provided to help prevent incidence of light on a semiconductor layer 231 of the transistor 23. Examples of the material of the light-blocking layer 211 include metals such as tungsten (W), titanium (Ti), chromium (Cr), iron (Fe) and aluminum (Al), metal nitrides and metal silicides, for example. Among them, the light-blocking layer 211 may contain tungsten. Among various metals, tungsten is excellent in heat resistance, and its optical density (OD) value does not decrease easily by heat treatment during manufacturing, for example. Thus, with the light-blocking layer 211 containing tungsten, the light-blocking layer 211 can effectively help prevent incidence of light on the semiconductor layer 231. Note that the light-blocking layer 211 serves as the scanning line 241.

The transistor 23 is arranged at the insulating layer 201. The transistor 23 includes the semiconductor layer 231, a gate electrode 232, and a gate insulating film 233. The semiconductor layer 231 is arranged at the insulating layer 201, and the gate electrode 232 is arranged at the insulating layer 202. The gate insulating film 233 is provided between the semiconductor layer 231 and the gate electrode 232.

The semiconductor layer 231 has a lightly doped drain (LDD) structure. More specifically, the semiconductor layer 231 includes a drain region 231d, a source region 231s, a channel region 231c, a low-concentration drain region 231a and a low-concentration source region 231b. The semiconductor layer 231 is made of polysilicon, for example. The region excluding the channel region 231c is doped with impurities that increase conductivity. The impurity concentration in the low-concentration drain region 231a is lower than the impurity concentration in the drain region 231d. The impurity concentration in the low-concentration source region 231b is lower than the impurity concentration in the source region 231s.

The gate electrode 232 is made of polysilicon doped with impurities that increase conductivity, for example. Note that the gate electrode 232 may be made of conductive materials of metals, metal oxides, and metal compounds. Further, the gate electrode 232 is electrically coupled to the light-blocking layer 211 via a conductive coupling portion 271 arranged in a hole extending through the insulating layers 201 and 202. Further, the gate insulating film 233 is constituted by a silicon oxide film deposited by a heat oxidation or chemical vapor deposition (CVD) method, for example.

The data line 242 and a relay layer 244 are arranged at the insulating layer 203. The data line 242 is electrically coupled to the source region 231s of the semiconductor layer 231 via a conductive coupling portion 272 arranged in a hole extending through the insulating layer 203. Further, the relay layer 244 has conductivity. The relay layer 244 is electrically coupled to the drain region 231d of the semiconductor layer 231 via a conductive coupling portion 273 arranged in a hole extending through the insulating layer 203.

A relay layer 245 is arranged at the insulating layer 204. The relay layer 245 has conductivity. The relay layer 245 is electrically coupled to the relay layer 244 via a conductive coupling portion 274 arranged in a hole extending through the insulating layer 204.

The capacitance element 25 is arranged at the insulating layer 205. The capacitance element 25 includes a first capacitance electrode 251, a second capacitance electrode 252, and a dielectric layer 253 arranged therebetween. The first capacitance electrode 251 is arranged at the insulating layer 205, and the dielectric layer 253 is arranged between the first capacitance electrode 251 and the second capacitance electrode 252. The second capacitance electrode 252 overlaps with the first capacitance electrode 251 in plan view. Each of the first capacitance electrode 251 and the second capacitance electrode 252 is made of a conductive material such as conductive polysilicon, metal silicide, metal, and a metal compound. In the present embodiment, each of the first capacitance electrode 251 and the second capacitance electrode 252 is made of titanium nitride (TiN). Further, the dielectric layer 253 is made of High-K being a high dielectric material.

The second capacitance electrode 252 is electrically coupled to the relay layer 245 via a conductive coupling portion 275 arranged in a hole extending through the insulating layer 205. A through hole is provided in the first capacitance electrode 251, and the coupling portion 275 is inserted into the through hole. Further, the first capacitance electrode 251 constitutes a part of the above-mentioned constant potential line 243. Further, the second capacitance electrode 252 corresponds to a “third relay electrode”.

A second relay electrode 246 is arranged at the first optical path length adjustment layer 221. The second relay electrode 246 is arranged in a layer between the transistor 23 and the lens layer 223. Further, the above-mentioned second capacitance electrode 252 is arranged in a layer between the transistor 23 and the second relay electrode 246. From another perspective, the above-mentioned second capacitance electrode 252 is arranged in the layer between the transistor 23 and the light-transmitting layer 222.

The first optical path length adjustment layer 221 is a path layer for adjusting an optical path length. Further, the upper surface of the first optical path length adjustment layer 221 is planarized by planarization processing such as chemical mechanical polishing (CMP). Further, the second relay electrode 246 is electrically coupled to the second capacitance electrode 252 via a third conductive portion 276.

The light-transmitting layer 222 includes a plurality of concave portions 222a. Each of the concave portions 222a is a curved recess formed in the light-transmitting layer 222, and is recessed in the Z2 direction. The lens layer 223 is arranged at the light-transmitting layer 222. The light-transmitting layer 222 is arranged in a layer between the transistor 23 and the lens layer 223 and is in contact with the lens layer 223. Further, the light-transmitting layer 222 servers as a pass layer for adjusting an optical path length.

The lens layer 223 is arranged in a layer between the transistor 23 and the pixel electrode 24. The lens layer 223 contains silicon oxynitride. The lens layer 223 includes a plurality of lenses each including a lens surface 223a. Each of the lens surfaces 223a is a curved convex surface protruding in the Z2 direction. The plurality of lens surfaces 223a are provided in a one-to-one relationship for the plurality of concave portions 222a. Each of the lens surfaces 223a is in contact with the corresponding concave portion 222a. Further, a refractive index of the lens layer 223 is different from a refractive index of the light-transmitting layer 222.

The passivation film 224 is arranged at the lens layer 223. Specifically, the passivation film 224 is arranged at a planar surface 223d on a side opposite to the plurality of lens surfaces 223a of the lens layer 223. The passivation film 224 is in contact with the planar surface 223d. As described later, the passivation film 224 is used to suppress film peeling of a conductive film 277x for forming a second conductive portion 277.

A first relay electrode 247 is arranged at the passivation film 224. The first relay electrode 247 has conductivity. The first relay electrode 247 is electrically coupled to the second relay electrode 246 via the second conductive portion 277.

The second optical path length adjustment layer 225 is a path layer for adjusting an optical path length. The upper surface of the second optical path length adjustment layer 225 is planarized by planarization processing such as CMP. The protective layer 226 is arranged at the second optical path length adjustment layer 225. The protective layer 226 is constituted by, for example, an inorganic material having a light-transmitting property and hygroscopicity such as borosilicate glass (BSG). The pixel electrode 24 is provided at the protective layer 226. The pixel electrode 24 is electrically coupled to the first relay electrode 247 via a first conductive portion 278. Therefore, the first relay electrode 247 is arranged in a layer between the lens layer 223 and the pixel electrode 24, and is electrically coupled to the pixel electrode 24 via the first conductive portion 278. Further, the alignment film 29 is provided at the pixel electrode 24.

Each of the scanning line 241, the data line 242, the constant potential line 243, the relay layer 244, the relay layer 245, the first relay electrode 247, and the second relay electrode 246, which are described above, may contain metal such as aluminum or a metal compound such as titanium nitride, and may be constituted by a single layer or a plurality of layers.

Further, the material of the coupling portions 271 to 275, the third conductive portion 276, the second conductive portion 277, and the first conductive portion 278 is not particularly limited, and examples of the material include metals such as tungsten, titanium, chromium, iron, and aluminum, metal nitrides, and metal silicides. Note that the coupling portions 271 to 275 may be contact plugs, or may be so-called trench electrodes formed along wall surfaces of the holes.

### A-4. Planar Structure of Plurality of Pixel Electrodes 24, Semiconductor Layer 231, and Second Capacitance Electrode 252

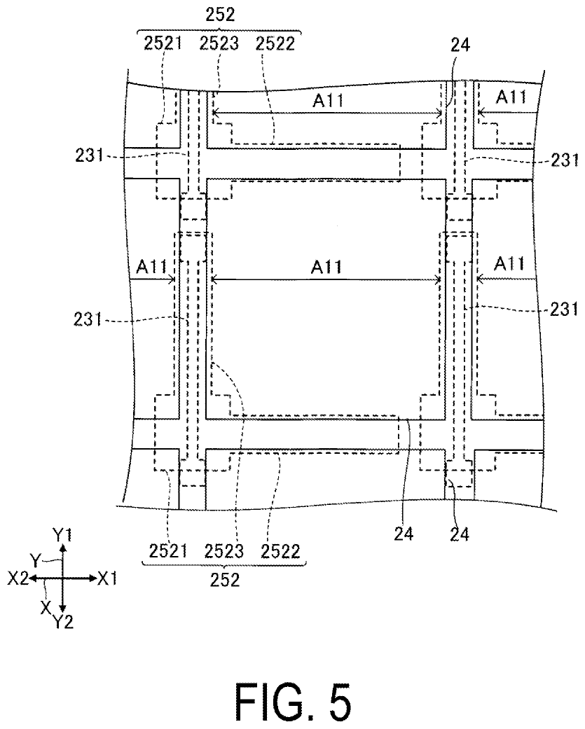

FIG. 5 is a diagram illustrating the planar arrangement of the plurality of pixel electrodes 24, the semiconductor layer 231, and the second capacitance electrode 252 in FIG. 2.

As illustrated in FIG. 5, a planar shape of each of the pixel electrodes 24 is a rectangular shape. The plurality of pixel electrodes 24 are spaced apart from each other and arranged in a matrix form in the X-axis direction and the Y-axis direction. The semiconductor layer 231 is arranged between the plurality of pixel electrodes 24 in plan view.

A planar shape of the second capacitance electrode 252 is substantially an L-like shape. The second capacitance electrode 252 includes a wide portion 2521, an extended portion 2522, and an extended portion 2523. The wide portion 2521 is provided at a position corresponding to the lower left corner of the four corners of the corresponding pixel electrode 24 in plan view in the drawing. The extended portion 2522 extends in the X1 direction from the wide portion 2521. The extended portion 2523 extends in the Y1 direction from the wide portion 2521.

Although omitted in illustration, each of the above-mentioned data lines 242 overlaps with the semiconductor layer 231 in plan view. Further, each of the data lines 242, each of the scanning lines 241, and each of the constant potential lines 243 are arranged between the plurality of pixel electrodes 24 in plan view. Note that a part of each of the data lines 242, a part of each of the scanning lines 241, and a part of each of the constant potential lines 243 may overlap with the plurality of pixel electrodes 24.

Further, a plurality of opening portions A11 are provided in the first substrate 2. Each of the opening portions A11 is a region that transmits the light LL. The plurality of opening portions A11 are regions in which the transistor 23 and various wiring lines are not provided. The plurality of pixel electrodes 24 are arranged in the plurality of opening portions A11.

### A-5. Partial Cross-sectional Structure of First Substrate 2

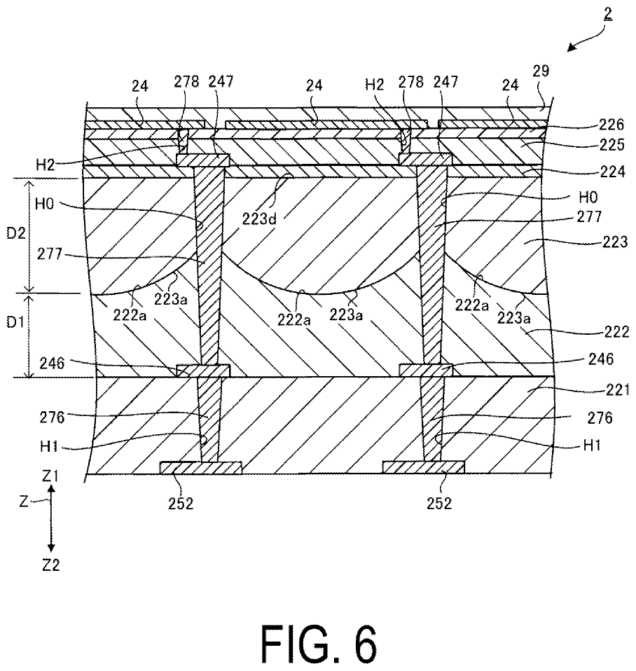

FIG. 6 is a diagram illustrating a part of the first substrate 2 in FIG. 4. As described above, the first substrate 2 includes the second capacitance electrode 252, the second relay electrode 246, the first relay electrode 247, and the plurality of pixel electrodes 24. FIG. 6 illustrates a cross-section corresponding to one pixel electrode 24 and the vicinity thereof.

As illustrated in FIG. 6, the first optical path length adjustment layer 221 is provided between the second capacitance electrode 252 and the second relay electrode 246. The third conductive portion 276 is arranged in a through hole H1 extending through the first optical path length adjustment layer 221. The third conductive portion 276 is a contact plug filling the through hole H1.

The light-transmitting layer 222, the lens layer 223, and the passivation film 224 are provided between the second relay electrode 246 and the first relay electrode 247. The second conductive portion 277 is arranged in a through hole H0 extending through the light-transmitting layer 222, the lens layer 223, and the passivation film 224. The second conductive portion 277 is a contact plug filling the through hole H0.

The second optical path length adjustment layer 225 and the protective layer 226 are provided between the first relay electrode 247 and the pixel electrode 24. The first conductive portion 278 is arranged in a through hole H2 extending through the second optical path length adjustment layer 225 and the protective layer 226. The first conductive portion 278 is a contact plug filling the through hole H2.

An aspect ratio of the through hole H0 is greater than an aspect ratio of each of the through holes H1 and H2. Thus, an aspect ratio of the second conductive portion 277 is greater than an aspect ratio of each of the third conductive portion 276 and the first conductive portion 278. This is because each of the thicknesses of the light-transmitting layer 222 and the lens layer 223 is larger than those of the other layers of the layered body 20. Note that the aspect ratio of the third conductive portion 276 is greater than the aspect ratio of the first conductive portion 278.

Even when the through hole H0 has a high aspect ratio, electrical coupling between the second relay electrode 246 and the first relay electrode 247 can be achieved by using the second conductive portion 277 being a contact plug filling the through hole H0. When a so-called trench conductive portion is used, a plane area of the through hole H0 is required to be increased significantly, which affects each of the lens surfaces 223a. Thus, it is difficult to use a trench conductive portion.

Further, the lens layer 223 includes the plurality of lens surfaces 223a protruding in the Z2 direction. The refractive index of the lens layer 223 and the refractive index of the light-transmitting layer 222 are different from each other. In the present embodiment, the refractive index of the lens layer 223 is higher than the refractive index of the light-transmitting layer 222. Thus, the light LL transmitted through the second substrate 3 and the liquid crystal layer 5 is refracted at the lens surface 223a, and advances to be converged. Thus, the risk of incidence of the light LL on the transistor 23 and various wiring lines can be suppressed.

The material of the lens layer 223 is silicon oxynitride. In contrast, for example, the material of the light-transmitting layer 222 is silicon oxide or silicon oxynitride. However, when the material of the light-transmitting layer 222 is silicon oxide, the refractive index difference from the lens layer 223 is easily increased.

Further, the passivation film 224 is provided between the lens layer 223 and the first relay electrode 247. The second conductive portion 277 described above is arranged in the through hole H0 extending through the lens layer 223 and the passivation film 224, and is electrically coupled to the first relay electrode 247.

A conductive film 227 is formed by removing the passivation film 224 and a part of the conductive film 277x arranged in the through hole H0, which is described later. At the time of forming the conductive film 277x, nitrogen leakage from the lens layer 223 containing silicon oxynitride occurs. Thus, when the passivation film 224 is not provided, and the conductive film 277x contacts directly with the lens layer 223, a film property of a lens layer 223x is changed due to an influence of nitrogen leakage. As a result, film peeling occurs at the conductive film 277x that is in contact with the lens layer 223x.

Meanwhile, in the present embodiment, the passivation film 224 is provided between the lens layer 223 and the first relay electrode 247. Thus, an influence of a change in film property of the lens layer 223 due to nitrogen leakage on the conductive film 277x can be suppressed. Thus, occurrence of film peeling of the conductive film 277x can be suppressed. Therefore, the risk that the peeled film causes fine scratches on the lens layer 223 and arching can be suppressed. As a result, the yield of the first substrate 2 can be improved, and hence quality and reliability of the electro-optical device 100 can be improved.

Further, the passivation film 224 may contain silicon oxide including boro-phosphosilicate glass (BPSG) and phosphosilicate glass (PSG) or silicon nitride. Further, the passivation film 224 containing silicon oxide includes a silicon oxide film formed by using TEOS (Si(OC₂H₅)₄). The passivation film 224 contains silicon oxide or silicon nitride. As a result, the risk of nitrogen leakage due to the passivation film 224 can be suppressed.

In particular, the passivation film 224 may contain silicon nitride (SiN). Since silicon nitride is contained, damage of the passivation film 224 at the time of patterning of the conductive film 277x can be suppressed particularly effectively while suppressing the risk of nitrogen leakage.

An average thickness D2 of the passivation film 224 is smaller than an average thickness D1 of the lens layer 223. Each of the average thicknesses D1 and D2 is an average length in the Z1 direction.

Here, in a case in which the passivation film 224 is not provided, and the conductive film 277x contacts directly with the lens layer 223, when the conductive film 277x is formed, a mechanical stress may be applied to the lens layer 223 and the layers below. It is considered that the difference in thermal expansion coefficients between the conductive film 277x and the lens layer 223 is significant because the average thickness D1 of the lens layer 223 is much larger than the thickness of the conductive film 277x. Thus, due to the mechanical stress described above, warpage is disadvantageously caused to the lens layer 223 and the layers below. As a result, film peeling may occur at the conductive film 277x.

A film formation temperature for the passivation film 224 is substantially the same as a film formation temperature for the conductive film 277x, and hence the passivation film 224 is less likely to be affected by a thermal stress at the time of forming the conductive film 277x. At the time of forming the passivation film 224, the film formation temperature that is substantially the same as the film formation temperature for the conductive film 277x is applied. Even when warpage or the like is caused to the lens layer 223 being a lower layer due to the passivation film 224, the passivation film 224 itself is not a material prone to film peeling. Thus, the passivation film 224 is less likely to suffer film peeling. Further, a stress such as warpage is applied in advance to the lower layer at the time of forming the conductive film 277x, and hence the conductive film 277x is less likely to suffer film peeling due to an influence of warpage.

Further, the passivation film 224 having the average thickness D2 smaller than the average thickness D1 is provided, and thus the passivation film 224 thinner than the lens layer 223 is in contact with the conductive film 277x. Thus, the difference in thicknesses between the conductive film 277x and the passivation film 224 is smaller than the difference in thicknesses between the conductive film 277x and the lens layer 223. Therefore, the passivation film 224 in contact with the conductive film 277x is less likely to suffer warpage due to the difference in thermal expansion coefficients as compared to the lens layer 223 in contact with the conductive film 277x, which has been described above. Therefore, film peeling of the conductive film 277x due to warpage can be suppressed by providing the passivation film 224 having the average thickness D2 smaller than the average thickness D1.

The average thickness D2 of the passivation film 224 may be 100 nm or larger and 1000 nm or smaller, may be 100 nm or larger and 500 nm or smaller, and may be 100 nm or larger and 200 nm or smaller. When the average thickness falls within such a range, the lens layer 223 can be formed evenly at the passivation film 224 as compared to a case in which the average thickness is outside of the range. At the same time, the risk that warpage is caused to the passivation film 224 and the layers below at the time of forming the conductive film 277x can be suppressed.

Further, as described above, examples of the material of the second conductive portion 277 include metals such as tungsten, titanium, chromium, iron, and aluminum, metal nitrides, and metal silicides. Among them, the second conductive portion 277 may contain tungsten. Among those metals, tungsten has an excellent filling property. Thus, the through hole H0 having a high aspect ratio can be filled evenly by using tungsten.

Moreover, the second conductive portion 277 may be constituted by a single material, and may be constituted by a plurality of layers.

FIG. 17 is a cross-sectional view illustrating a second conductive portion 277a in a modification example. As illustrated in FIG. 17, the second conductive portion 277a may be constituted by a plurality of layers. For example, the second conductive portion 277a includes a barrier layer 2771 and a conductive layer 2772. The barrier layer 2771 is in contact with an inner wall surface forming the through hole H0. The conductive layer 2772 is arranged on the inner side of the barrier layer 2771, and fills the through hole H0.

The barrier layer 2771 may contain tungsten nitride (WN) or titanium nitride (TiN). The barrier layer 2771 contains tungsten nitride or titanium nitride, and thus the risk that the components of the conductive layer 2772 are dispersed to the lens layer 223 or the like can effectively be suppressed.

### A-6. Planar Structure of First Substrate 2

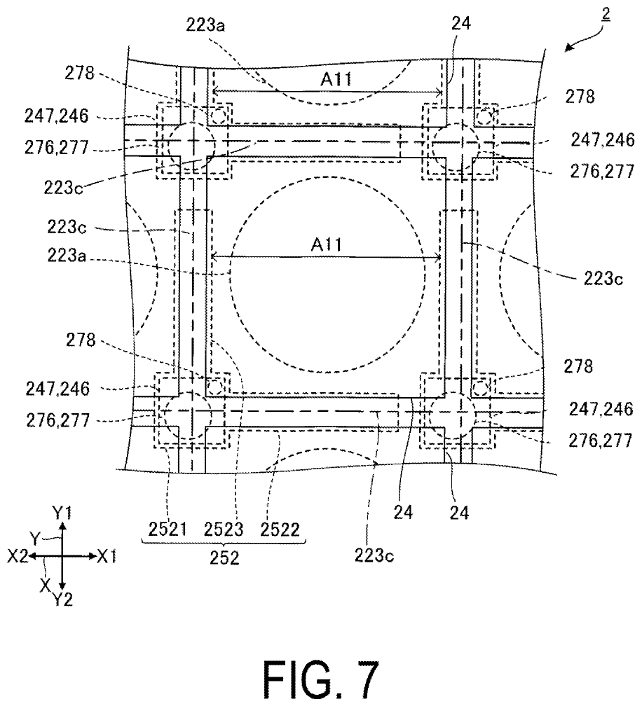

FIG. 7 is a plan view illustrating a part of the first substrate 2 in FIG. 6. As illustrated in FIG. 6, the plurality of lens surfaces 223a are arranged in a matrix form in plan view. The plurality of lens surfaces 223a are provided in a one-to-one relationship for the plurality of pixel electrodes 24. One lens surface 223a overlaps with one pixel electrode 24 in plan view.

In the example illustrated in FIG. 7, a planar shape of each of the lens surfaces 223a is changed from a rectangular shape to a circular shape towards the apex in the Z2 direction. Note that, in FIG. 6, a boundary between two adjacent lens surfaces 223a is indicated with the boundary line 223c indicated with the two-dot chain line.

Further, the first relay electrode 247, the second relay electrode 246, the third conductive portion 276, the second conductive portion 277, and the first conductive portion 278 overlap with the wide portion 2521 of the second capacitance electrode 252 in plan view.

A planar shape of the first relay electrode 247 is a rectangular shape. Further, a planar shape of the second relay electrode 246 is a rectangular shape, and is the same as the planar shape of the first relay electrode 247. Further, in the illustrated example, a plane area of the second relay electrode 246 is equivalent to a plane area of the first relay electrode 247.

The second relay electrode 246 overlaps with the first relay electrode 247 in plan view. Thus, as compared to a case in which the second relay electrode 246 does not overlap with the first relay electrode 247 in plan view, the opening rate of the opening portions A11 can be improved.

The planar shape of each of the third conductive portion 276, the second conductive portion 277, and the first conductive portion 278 is a circular shape in the illustrated example. The third conductive portion 276, the second conductive portion 277, and the first conductive portion 278 are provided at a position corresponding to the lower left corner of the four corners of the corresponding pixel electrode 24 in plan view in the drawing.

The first conductive portion 278 is arranged at a position different from the second conductive portion 277, and does not overlap with the second conductive portion 277 in plan view. Thus, when the first conductive portion 278 overlaps with the pixel electrode 24 in plan view, coupling between the first conductive portion 278 and the pixel electrode 24 is facilitated. Further, when the second conductive portion 277 does not overlap with the first conductive portion 278, a portion in which the pixel electrode 24 and the second conductive portion 277 overlap with each other in plan view can be reduced. Thus, reduction in opening rate due to the second conductive portion 277 can be suppressed.

Further, as described above, the second relay electrode 246 overlaps with the first relay electrode 247 in plan view, and thus the second conductive portion 277 and the third conductive portion 276 can overlap with each other in plan view. Therefore, the second relay electrode 246, the first relay electrode 247, the second conductive portion 277, and the third conductive portion 276 can overlap with each other in plan view. Thus, the opening rate can be improved. In addition, reduction in plane area of each of the lens surfaces 223a can be suppressed. As a result, the restriction on the layout of the first substrate 2 is satisfied, and thus a configuration suitable for miniaturization can be obtained. Further, the second conductive portion 277 and the third conductive portion 276 are contact plugs, and thus the opening rate can be particularly improved.

Note that, as illustrated in FIG. 6, the second conductive portion 277 has an inverted cone shape. Therefore, an outer edge of the second conductive portion 277 surrounds an outer edge of a bottom surface in plan view. Note that the same holds true for the first conductive portion 278 and the third conductive portion 276.

### A-7. Method of Manufacturing First Substrate 2

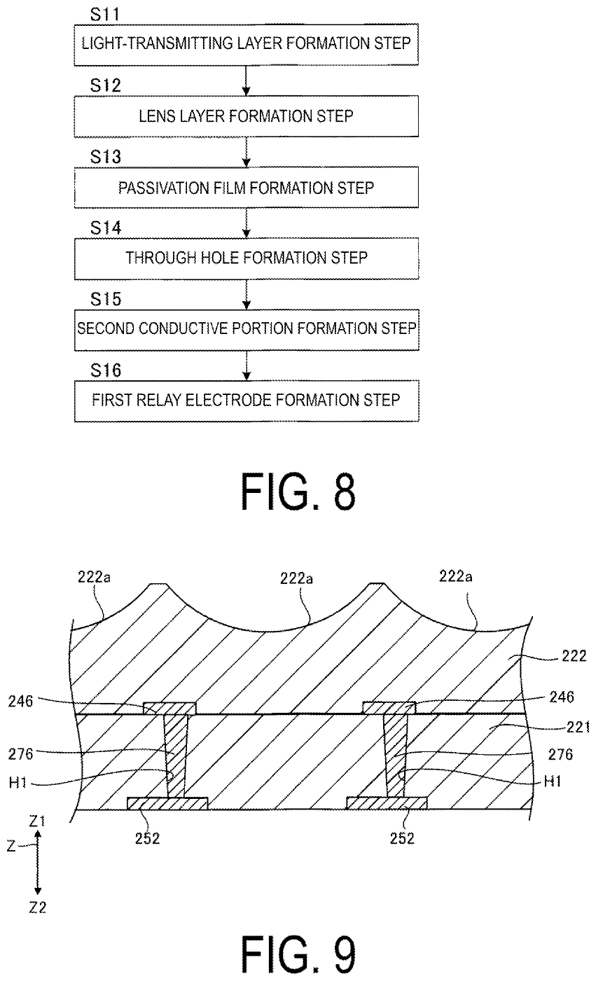

FIG. 8 is a diagram illustrating a flow of a method of manufacturing a part of the first substrate 2 in FIG. 6. A method of manufacturing the layers from the second relay electrode 246 to the first relay electrode 247 in the first substrate 2 is described below.

As illustrated in FIG. 8, the method of manufacturing the first substrate 2 includes a light-transmitting layer formation step S11, a lens layer formation step S12, a passivation film formation step S13, a through hole formation step S14, a second conductive portion formation step S15, and a first relay electrode formation step S16.

Note that, for example, the plurality of element portions each including a portion corresponding to each of the above-mentioned pixel electrodes 24 are formed at a wafer such as a quartz substrate, which is a base material of the substrate 21, and then the wafer is individualized. Through individualization, the plurality of first substrates 2 are obtained.

FIG. 9 is a diagram for describing the light-transmitting layer formation step S11. As illustrated in FIG. 9, in the light-transmitting layer formation step S11, the light-transmitting layer 222 is formed at the first optical path length adjustment layer 221. The light-transmitting layer 222 is obtained by subjecting a film, which is formed by, for example, the chemical vapor deposition (CVD) method, to etching by using a mask. In this manner, the light-transmitting layer 222 is formed. Through etching, the plurality of concave portions 222a are formed in the light-transmitting layer 222.

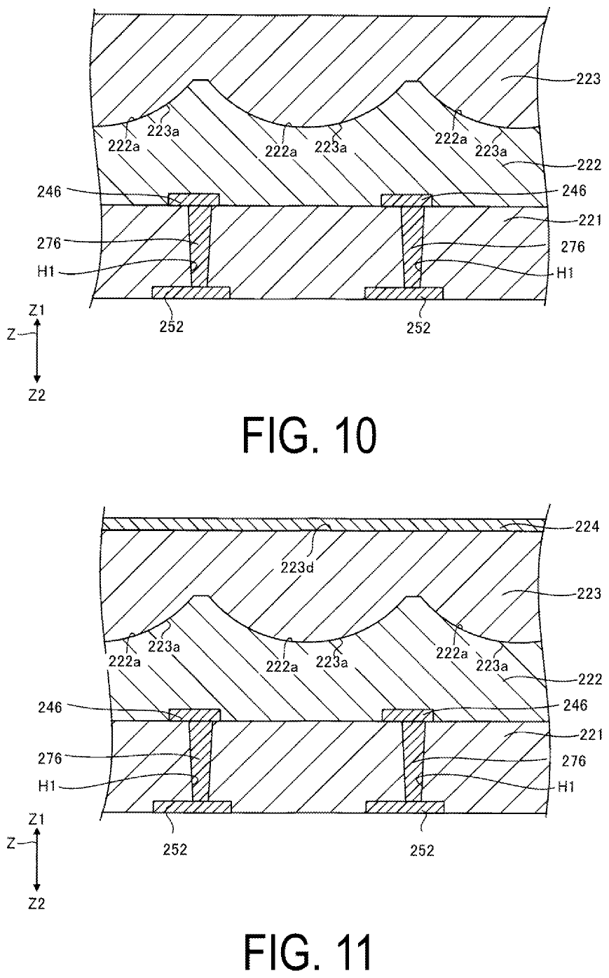

FIG. 10 is a diagram for describing the lens layer formation step S12. As illustrated in FIG. 10, in the lens layer formation step S12, the lens layer 223 is formed at the light-transmitting layer 222. The lens layer 223 is formed at the light-transmitting layer 222 by, for example, the CVD method so as to fill the plurality of concave portions 222a, and then is planarized by planarization processing such as CMP. The lens layer 223 is constituted by a silicon oxynitride film.

FIG. 11 is a diagram for describing the passivation film formation step S13. As illustrated in FIG. 11, in the passivation film formation step S13, the passivation film 224 is formed. The passivation film 224 is formed at the lens layer 223 by, for example, the CVD method or the atomic layer deposition (ALD) method.

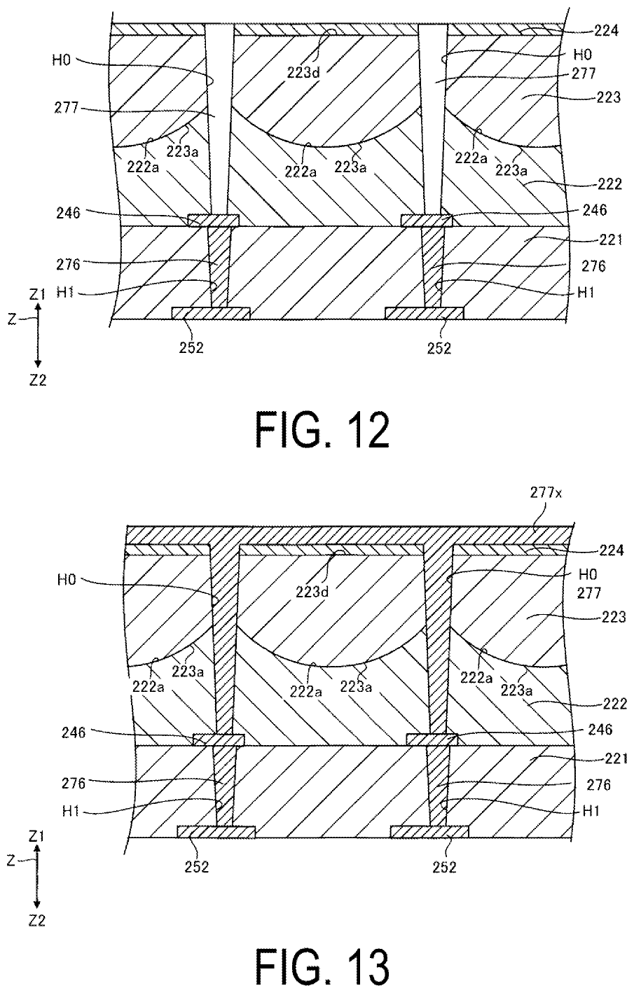

FIG. 12 is a diagram for describing the through hole formation step S14. As illustrated in FIG. 12, in the through hole formation step S14, the plurality of through holes H0 extending through the light-transmitting layer 222, the lens layer 223, and the passivation film 224 are formed. The plurality of through holes H0 are formed by photoetching, for example.

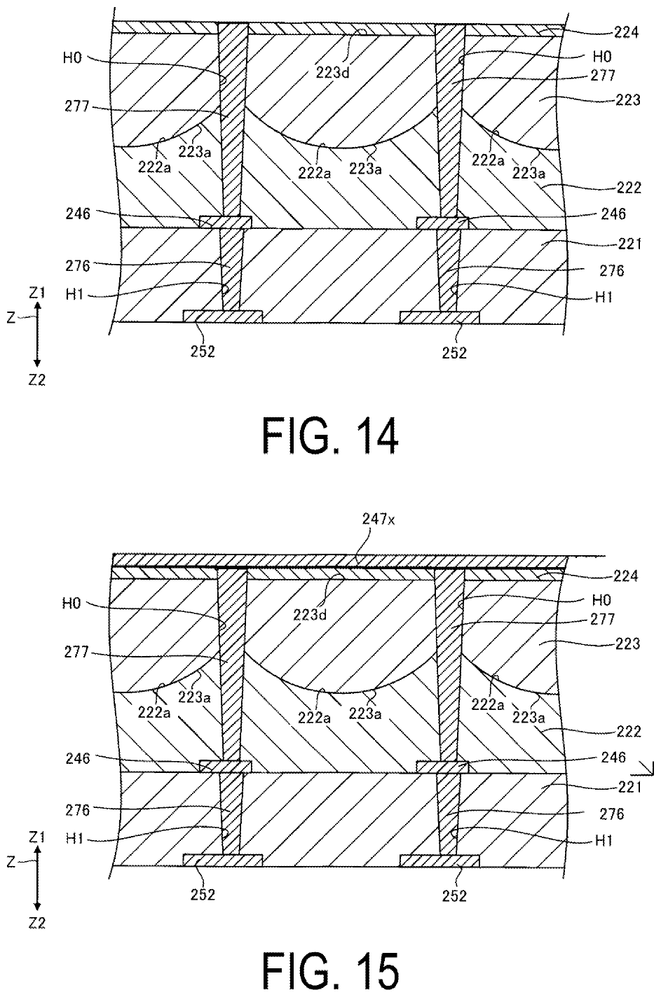

Each of FIG. 13 and FIG. 14 is a diagram for describing the second conductive portion formation step S15. As illustrated in FIG. 13, in the second conductive portion formation step S15, first, the conductive film 277x is formed at the passivation film 224. The conductive film 277x is formed to fill the plurality of through holes H0. The conductive film 277x is formed by, for example, the CVD method. Subsequently, a part of the conductive film 277x is removed from the surface of the conductive film 277x by planarization processing such as CMP. As a result, as illustrated in FIG. 14, the portion of the conductive film 277x, which is at the passivation film 224, is removed, and the portions corresponding to the plurality of through holes H0 are left. The portions of the conductive film 277x, which are left in the plurality of through holes H0, are the plurality of second conductive portions 277.

In a case in which the passivation film 224 is not provided, when the conductive film 277x is formed in the second conductive portion formation step S15, film peeling may occur at the conductive film 277x. It is considered the risk is caused by nitrogen leakage from the lens layer 223 and warpage due to application of a mechanical stress. In particular, film peeling is more likely to occur at the outer periphery of the wafer.

When the passivation film 224 is provided, an influence of a change in film property of the lens layer 223 due to nitrogen leakage on the conductive film 277x can be suppressed. Moreover, an influence of a mechanical stress due to formation of the conductive film 277x is suppressed. Thus, occurrence of film peeling of the conductive film 277x can be suppressed. As a result, the risk that the peeled film causes fine scratches on the lens layer 223 and arching can be suppressed.

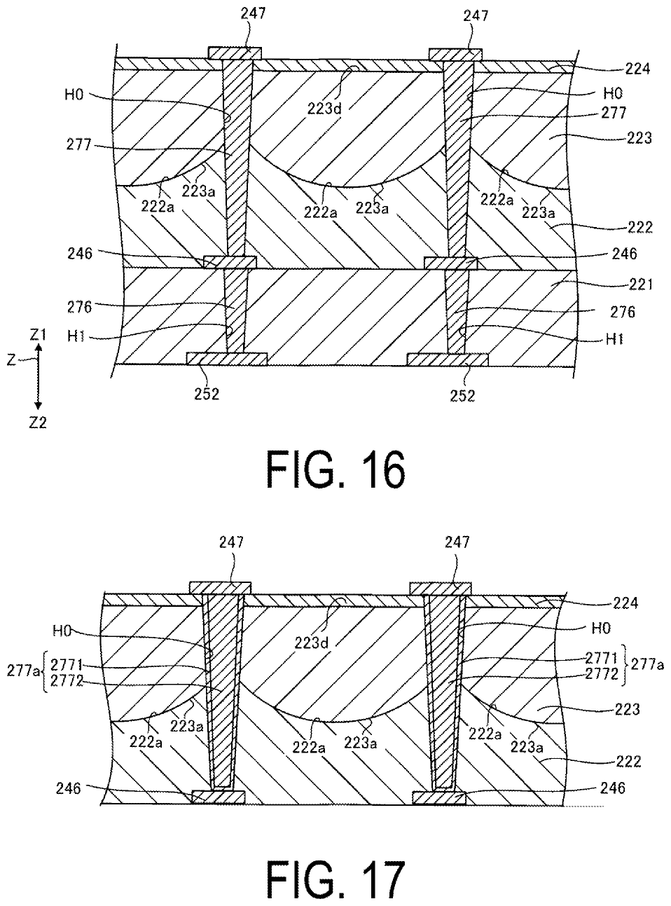

Each of FIG. 15 and FIG. 16 is a diagram for describing the first relay electrode formation step S16. As illustrated in FIG. 15, first, an electrode film 247x is formed at the passivation film 224. The electrode film 247x is formed by using, for example, a material having conductivity by the physical vapor deposition (PVD) method or the spattering method. Subsequently, the electrode film 247x is subjected to patterning through etching. As a result, as illustrated in FIG. 16, the first relay electrode 247 is formed. The thickness of each of the electrode film 247x and the first relay electrode 247 is not particularly limited, and is approximately 100 nm or larger and 300 nm or smaller, for example.

Even when an over-edge is generated at the electrode film 247x at the time of etching of the electrode film 247x, presence of the passivation film 224 mitigates an impact on the lens layer 223. Thus, the risk that irregularities are generated on the surface of the lens layer 223, in other words, the risk that irregularities are generated at the boundary between the lens layer 223 and the passivation film 224 can be suppressed. Thus, the risk that the transmittance is reduced by irregularities on the surface of the lens layer 223 can be suppressed.

In contrast, when the passivation film 224 is not provided, and the electrode film 247x is formed at the lens layer 223, planarity of the surface of the lens layer 223 may be degraded due to an over-edge of the electrode film 247x. As a result, the transmittance may be reduced due to irregularities on the surface of the lens layer 223.

As described above, the passivation film 224 is provided, and thus the risk that fine scratches and irregularities are generated on the surface of the lens layer 223 and the risk that arcing occurs can be suppressed. Thus, the yield of the first substrate 2 can be improved, and hence quality and reliability of the electro-optical device 100 can be improved.

Note that the third conductive portion 276 and the first conductive portion 278 are formed by a method similar to that of the second conductive portion 277.

Further, a method of forming the second conductive portion 277a that is illustrated in FIG. 17 is briefly described. First, a barrier film being a base material of the barrier layer 2771 is formed at the passivation film 224 by, for example, the CVD method or the ALD method. The barrier film is formed to cover the inner wall surfaces of the plurality of through holes H0. Subsequently, a conductive film being a base material of the conductive layer 2772 is formed by, for example, the CVD method. The conductive film is formed to fill the inside of each of the barrier layers 2771. After that, the portions of the barrier film and the conductive film, which are at the passivation film 224, are removed by planarization processing such as CMP. As a result, the conductive layer 2772 is formed on the inner side of the barrier layer 2771 of each of the through holes H0. In this manner, the second conductive portion 277a including the barrier layer 2771 and the conductive layer 2772 is formed.

Note that the third conductive portion 276 and the first conductive portion 278 may also include a barrier layer and a conductive layer similarly to the second conductive portion 277. Further, in the present embodiment, the third conductive portion 276 and the first conductive portion 278 are contact plugs, but may be so-called trench electrodes.

### B. Second Embodiment

A second embodiment is described. Note that in each of the following examples, the reference signs used in the description of the first embodiment are used for elements whose functions are similar to those in the first embodiment, and each detailed description thereof is omitted as appropriate.

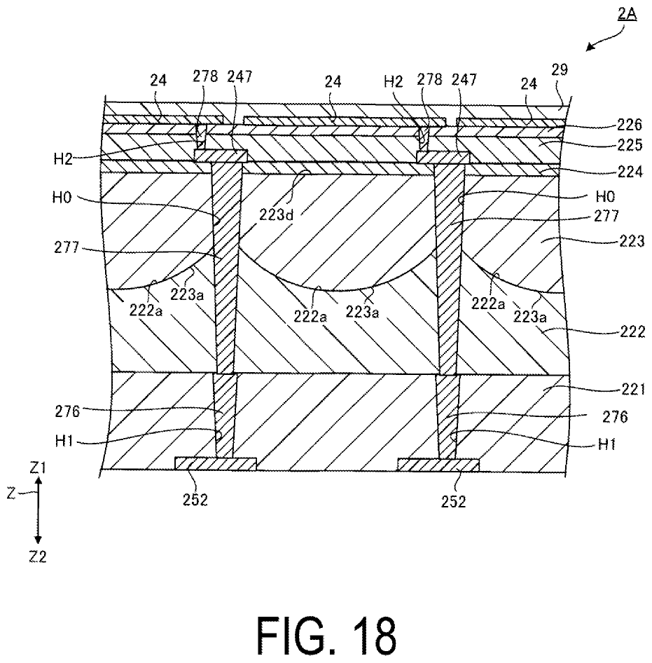

FIG. 18 is a cross-sectional view illustrating a part of a first substrate 2A according to the second embodiment. The present embodiment is different from the first embodiment in that the first substrate 2A is provided in place of the first substrate 2.

As illustrated in FIG. 18, the second relay electrode 246 is omitted from the first substrate 2A. The second conductive portion 277 and the third conductive portion 276 are coupled to each other at the first substrate 2A. Thus, the third conductive portion 276 electrically couples the second conductive portion 277 and the second capacitance electrode 252 to each other. The second capacitance electrode 252 corresponds to a “third relay electrode”. Further, as in the first embodiment, the second conductive portion 277 and the third conductive portion 276 overlap with each other in plan view.

The second conductive portion 277 and the third conductive portion 276 are coupled to each other, and thus the second relay electrode 246 can be omitted. As a result, the work of forming the second relay electrode 246 can be omitted. Moreover, as in the first embodiment, the second conductive portion 277 and the third conductive portion 276 overlap with each other in plan view, and hence reduction in opening rate can be suppressed better than when those portions do not overlap with each other in plan view.

Further, in addition to the second conductive portion 277 and the third conductive portion 276, a part of the second capacitance electrode 252, and the first relay electrode 247 overlap in plan view. Thus, as compared to a case in which those portions do not overlap with each other in plan view, the opening rate can be improved. As a result, the restriction on the layout of the first substrate 2A is satisfied, and thus a configuration suitable for miniaturization can be obtained.

### C: Third Embodiment

A third embodiment is described. Note that in each of the following examples, the reference signs used in the description of the first embodiment are used for elements whose functions are similar to those in the first embodiment, and each detailed description thereof is omitted as appropriate.

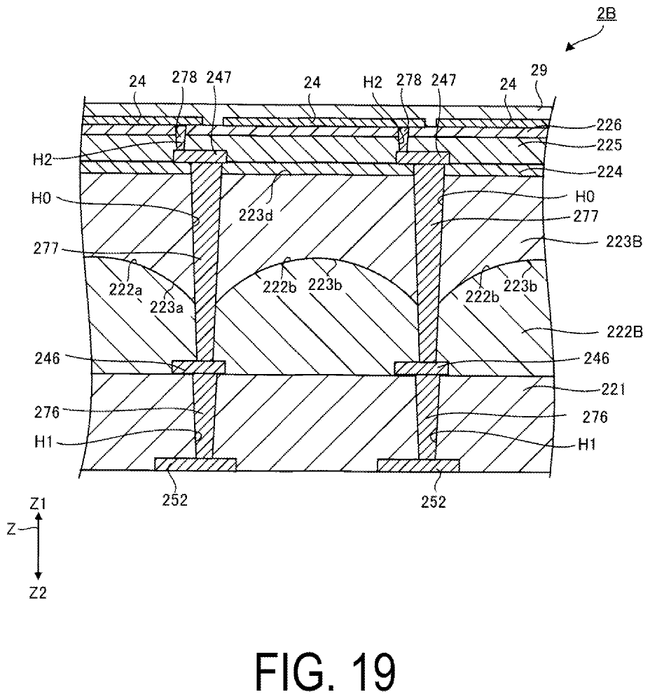

FIG. 19 is a sectional view illustrating a part of a first substrate 2B according to the third embodiment. The present embodiment is different from the first embodiment in that the first substrate 2B is provided in place of the first substrate 2.

As illustrated in FIG. 19, the first substrate 2B includes a light-transmitting layer 222B and a lens layer 223B in place of the light-transmitting layer 222 and the lens layer 223.

The light-transmitting layer 222B includes a plurality of convex surfaces 222b. Each of the convex surfaces 222b is a curved surface protruding in the Z1 direction from the first optical path length adjustment layer 221. The lens layer 223B is arranged at the light-transmitting layer 222B. The lens layer 223B includes a plurality of lenses each including a concave lens surface 223b. Each of the lens surfaces 223b is a curved surface recessed in the Z2 direction. The plurality of lens surfaces 223b are provided in a one-to-one relationship for the plurality of convex surfaces 222b. Each of the lens surfaces 223b is in contact with the corresponding concave surface 222b.

A refractive index of the lens layer 223B is different from a refractive index of the light-transmitting layer 222B. In the present embodiment, the refractive index of the lens layer 223B is higher than the refractive index of the light-transmitting layer 222B. For example, each of the lens layer 223B and the light-transmitting layer 222B contains silicon oxynitride. The refractive index of the lens layer 223B can be higher than the refractive index of the light-transmitting layer 222B by adjusting a ratio of nitrogen and oxygen.

In the present embodiment, the passivation film 224 is arranged at the lens layer 223B as in the first embodiment. Thus, film peeling of the conductive film 277x for forming the second conductive portion 277 can be suppressed.

### D. Modification Example

The embodiments exemplified above may be modified in various ways. Specific modified aspects that may be applied to the above-described embodiments are exemplified below.

For example, another conductive portion may be provided at a layer under the third conductive portion 276. In this case, the conductive portion may overlap with the third conductive portion 276 in plan view. In other words, when the first substrate 2 includes a plurality of conductive portions, the plurality of conductive portions overlap with each other in plan view. When the plurality of conductive portions overlap with each other in plan view, the opening rate can easily be improved. Further, the restriction on the layout is satisfied, and thus a configuration suitable for miniaturization can be obtained.

The driving type of the “electro-optical device” is not limited to a vertical electric field type, and may be a horizontal electric field type. Note that examples of the horizontal electric field type include an in-plane switching (IPS) mode. In addition, examples of the vertical electric field type include a twisted nematic (TN) mode, a vertical alignment (VA), a PVA mode, and an optically compensated bend (OCB) mode.

In each of the embodiments described above, the electro-optical device 100 of an active matrix type is illustrated, but the present disclosure is not limited thereto. For example, the drive type of the electro-optical device 100 may be a passive matrix type.

Further, in the above description, the liquid crystal display device is given as an example of the “electro-optical device”, but the “electro-optical device” is not limited thereto. For example, the “electro-optical device” is applicable to an image sensor or the like.

### 2. Electronic Apparatus

The electro-optical device 100 can be used in various types of electronic apparatuses.

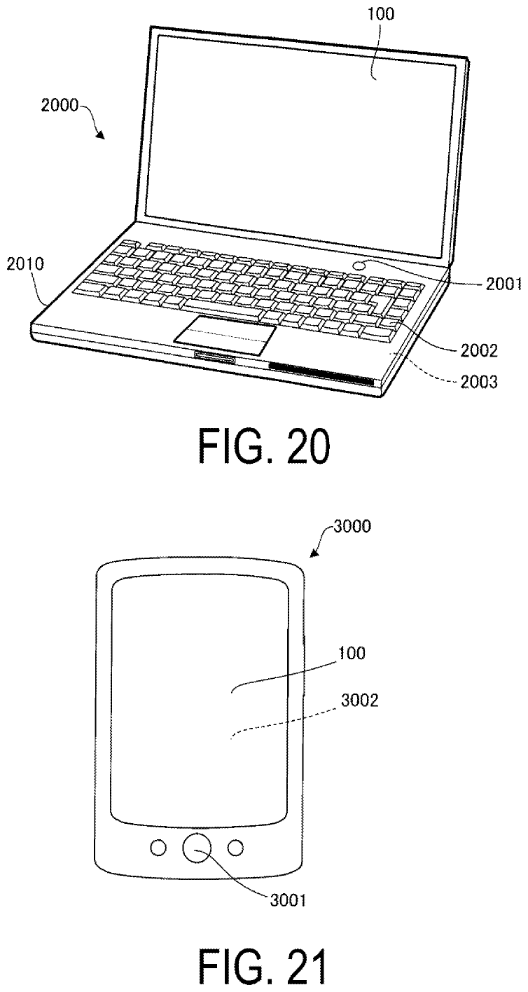

FIG. 20 is a perspective view illustrating a personal computer 2000 that is an example of the electronic apparatus. The personal computer 2000 includes the electro-optical device 100 that displays various images, a main body unit 2010 in which a power switch 2001 and a keyboard 2002 are installed, and a control unit 2003. The control unit 2003 includes, for example, a processor and a memory, and controls the operation of the electro-optical device 100.

FIG. 21 is a plan view illustrating a smartphone 3000 that is an example of the electronic apparatus. The smartphone 3000 includes an operation button 3001, an electro-optical device 100 that displays various images, and a control unit 3002. The screen content displayed on the electro-optical device 100 is changed according to an operation of the operation button 3001. The control unit 3002 includes, for example, a processor and a memory, and controls an operation of the electro-optical device 100.

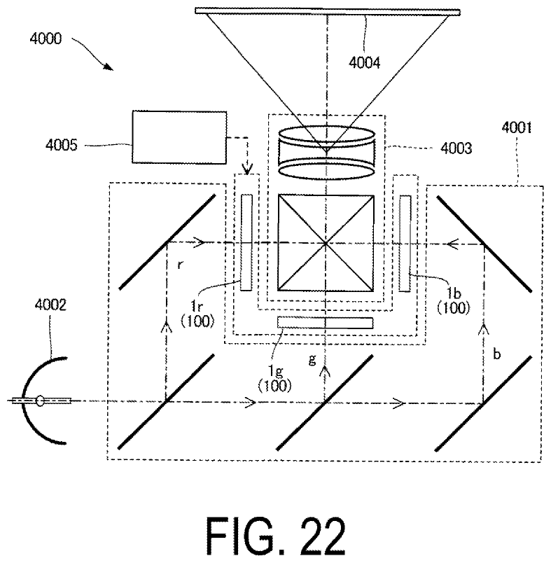

FIG. 22 is a schematic diagram illustrating a projector that is an example of the electronic apparatus. A projection-type display apparatus 4000 is, for example, a three-panel projector. An electro-optical device 1r is an electro-optical device 100 corresponding to a red display color, an electro-optical device 1g is an electro-optical device 100 corresponding to a green display color, and an electro-optical device 1b is an electro-optical device 100 corresponding to a blue display color. In other words, the projection-type display device 4000 includes three electro-optical devices 1r, 1g, and 1b corresponding to red, green, and blue display colors, respectively. A control unit 4005 includes, for example, a processor and a memory, and controls the operation of the electro-optical device 100.

An illumination optical system 4001 supplies a red component r of light emitted from an illumination device 4002, which is a light source, to the electro-optical device 1r, supplies a green component g to the electro-optical device 1g, and supplies a blue component b to the electro-optical device 1b. Each of the electro-optical devices 1r, 1g, and 1b serves as an optical modulator such as a light valve that modulates each monochromatic light supplied from the illumination optical system 4001 in accordance with a displayed image. A projection optical system 4003 combines light emitted from the respective electro-optical devices 1r, 1g, and 1b, and projects the combined light onto a projection surface 4004.

The above electronic apparatus includes the electro-optical device 100 described above and the control unit 2003, 3002, or 4005. The above-mentioned electro-optical device 100 has excellent quality and reliability. Thus, with the electro-optical device 100, degradation in display quality of the personal computer 2000, the smartphone 3000, or the projection-type display device 4000 can be suppressed.

Note that electronic apparatuses to which the electro-optical device of the present disclosure is applied are not limited to the illustrated apparatuses, and examples of the electronic apparatus include personal digital assistants (PDAs), digital still cameras, televisions, video cameras, car navigation devices, in-vehicle displays, electronic notebooks, electronic paper, calculators, word processors, workstations, videophones, and point-of-sale (POS) terminals. Further, examples of the electronic apparatus to which the present disclosure is applied may include printers, scanners, copiers, video players, and apparatuses including a touch panel.

Although the present disclosure has been described above based on the preferred embodiments, the present disclosure is not limited to the above-described embodiments. Further, the configuration of each component of the present disclosure can be replaced by any configuration that exhibits the same function as that of the above-described embodiment, and any configuration can be added.

What is claimed is:

1. An electro-optical device comprising:
a transistor including a drain region;
a pixel electrode provided corresponding to the transistor;
a lens layer arranged in a layer between the transistor and the pixel electrode and including silicon oxynitride;
a first relay electrode arranged in a layer between the lens layer and the pixel electrode and electrically coupled to the pixel electrode via a first conductive portion;
a passivation film arranged in a layer between the lens layer and the first relay electrode and being in contact with the lens layer; and
a second conductive portion arranged in a through hole extending through the lens layer and the passivation film and electrically coupled to the first relay electrode.

2. The electro-optical device according to claim 1, wherein
the passivation film includes silicon oxide or silicon nitride.

3. The electro-optical device according to claim 1, wherein
the second conductive portion includes tungsten.

4. The electro-optical device according to claim 1, wherein
an average thickness of the passivation film is smaller than an average thickness of the lens layer.

5. The electro-optical device according to claim 1, wherein
an average thickness of the passivation film is from 100 nm to 1000 nm.

6. The electro-optical device according to claim 1, wherein
the first conductive portion and the second conductive portion are arranged at different positions in plan view.

7. The electro-optical device according to claim 1, further comprising
a second relay electrode arranged in a layer between the transistor and the lens layer and electrically coupled to the first relay electrode via the second conductive portion, wherein
the first relay electrode and the second relay electrode overlap with each other in plan view.

8. The electro-optical device according to claim 7, further comprising:
a third relay electrode arranged in a layer between the transistor and the second relay electrode; and
a third conductive portion configured to electrically couple the second relay electrode and the third relay electrode to each other, wherein
the second conductive portion and the third conductive portion overlap with each other in plan view.

9. The electro-optical device according to claim 1, further comprising:
a light-transmitting layer arranged in a layer between the transistor and the lens layer and being in contact with the lens layer;
a third relay electrode arranged in a layer between the transistor and the light-transmitting layer; and
a third conductive portion configured to electrically couple the second conductive portion and the third relay electrode to each other, wherein
the second conductive portion and the third conductive portion overlap with each other in plan view and are coupled to each other.

10. The electro-optical device according to claim 1, wherein
the lens layer includes a plurality of lens surfaces and a planar surface on an opposite side of the plurality of lens surfaces, and
the passivation film is in contact with the planar surface.

11. An electronic apparatus comprising:
the electro-optical device according to claim 1; and
a control unit configured to control an operation of the electro-optical device.
